(19) United States
(12) Patent Application Publication
(10) Pub. No.: US 2017/0004930 A1
(43) Pub. Date: Jan. 5, 2017

(54) ELECTROCHEMICAL CELL, ENERGY STORAGE SYSTEM AND VEHICLE COMPRISING SUCH A SYSTEM

(71) Applicant: COMMISSARIAT À L'ENERGIE ATOMIQUE ET AUX ÉNERGIES ALTERNATIVES, Paris (FR)

(72) Inventors: Matthieu PICOT, Grenoble (FR); Philippe AZAIS, Saint Egreve (FR)

(73) Assignee: COMMISSARIAT À L'ENERGIE ATOMIQUE ET AUX ÉNERGIES ALTERNATIVES, Paris (FR)

(21) Appl. No.: 15/108,966

(22) PCT Filed: Dec. 19, 2014
(86) PCT No.: PCT/EP2014/078780

§ 371 Date: Jun. 29, 2016

(30) Foreign Application Priority Data
Jan. 3, 2014 (FR) 14 50030

(51) Int. Cl. H01G 11/08; H01M 10/0525; H01G 11/68; H01G 11/04; H01G 11/62; H01G 11/60; H01M 12/00; H01G 11/34

(52) U.S. Cl. CPC H01G 11/08; H01M 12/005; H01M 10/0525; H01G 11/34; H01G 11/04; H01G 11/62; H01G 11/60; H01G 11/68; H01M 2220/20; H01M 2300/0028

(57) ABSTRACT

An electrochemical cell including a shell delimiting a space filled with an electrolytic solution, and a set of at least two different electrochemical systems selected from among a supercapacitor, a hybrid supercapacitor, and an accumulator, the set being arranged in the space filled with the electrolytic solution. A system for storing and restoring electric energy, or a vehicle, or a hybrid vehicle car can include such an electrochemical cell and can include such a system for storing and restoring electric energy.

### TECHNICAL FIELD

The present invention relates to an electrochemical cell comprising at least two different electrochemical systems, these electrochemical systems being differentiated by distinct power and energy densities, having the impact of operating in an antagonistic way.

The present invention also relates to a system for storing and restoring electric energy, comprising such an electrochemical cell.

These electrochemical cell and electric energy storage and restoration system notably find their application in the electric power supply of vehicles and more particularly of hybrid vehicles.

### STATE OF THE PRIOR ART

At the present time, the setting up into place of environmental standards, with the purpose of preserving at best the health of persons and safeguarding their environment, is part of the major concerns of International and European instances.

As an example, in the automotive field, the European Union issues environmental standards which aim at reducing the emissions of pollutants in air, from among which carbon dioxide CO₂. In order to do this, these standards set limits not to be exceeded, with the threat of economical sanctions.

As these standards constantly change in the sense of a reduction of emissions of pollutants, automotive manufacturers are forced to find technological solutions allowing to limit at most the amount of pollutants discharged into the atmosphere by vehicles such as cars, buses and trucks.

From among the solutions retained by automotive manufacturers for limiting these emissions of pollutants, hybridization technology seems to have been established as a key technology in the mean and long terms.

Hybridization is, by definition, the combination of at least two distinct sources of energy used for the movement of a vehicle.

In the automotive field, the most common hybridization form combines heat energy and electric energy. A hybrid vehicle therefore resorts to a heat engine and to an electric system applying for example a supercapacitor or an accumulator.

In this automotive field, different degrees of hybridization are distinguished depending on the significance of the electric system in the locomotion of the vehicle and on how this electric system is combined with the heat engine.

Table 1 below shows the different types of hybrid vehicles known to this day, from the one which has the lowest hybridization degree (a so-called <<micro-hybrid>> vehicle) to the one which has the most significant hybridization degree (a so-called <<rechargeable hybrid>> vehicle). Anglo-Saxon terminology conventionally used in the field of hybrid automobiles, is specified facing the corresponding French terminology. Table 1 further specifies for each hybridization degree, the power delivered by the electric system as well as the nature of the electrochemical system present in this electric system and allowing storage and restoration of the electric energy.

TABLE 1

| Hybridization degree | | Delivered | |
|---|---|---|---|
| French | Anglo-Saxon | power | Electrochemical |
| terminology | terminology | (kW) | system |
| Micro-hybrid | Stop and | 2 | supercapacitor |
| | Start | | |
| Semi-hybrid | Mild hybrid | from 8 to | hybrid |
| | | 15 | supercapacitor |
| Full-hybrid | Full hybrid | from 20 | accumulator |
| | | to 25 | |
| Rechargeable | Plug-in | 30 | accumulator |
| hybrid | hybrid | | |

The electric system of a micro-hybrid or <<stop and start>> vehicle applies a reversible alternator, further called an <<alterno-starter>>, which gives the possibility of ensuring starting as well as automatic cutting out of the heat engine upon immobilization of the vehicle, which may be frequent, notably in conurbations (red lights, traffic jams, for example).

The electric system of a semi-hybrid or <<mild hybrid>> vehicle gives the possibility of recovering the kinetic energy produced during the deceleration and braking phases, further of ensuring the functionalities described earlier for the electric system of a micro-hybrid vehicle. This recovered kinetic energy, which is stored in supercapacitors, provides a supply of power to the heat engine in the starting, acceleration and resumption phases of the vehicle.

A full-hybrid or <<full hybrid>> vehicle may, as for it, be propelled by the electric system alone, by the heat engine alone or by the combination of both systems. The electric energy, which is produced by the heat engine as well as by the recovery of the energy upon braking, is stored in accumulators.

A rechargeable hybrid vehicle or <<plug-in hybrid>> vehicle is an alternative of the full-hybrid vehicle, in which the recharging of the accumulator of the vehicle at a standstill is carried out independently of the operation of the heat engine, by means of a current socket.

Depending on the degree of hybridization of the vehicle and, by doing so, on the power to be delivered by the electric system, the electrochemical systems allowing storage and restoration of the electric energy are not the same.

Thus, for a degree of micro-hybrid hybridization, the electrochemical system is typically a supercapacitor, i.e. a device which although not allowing storage of a significant amount of electric energy, gives the possibility of recovering it at a high rate. It is specified that the terms of <<supercapacitance>> and <<ultracapacitance>>, both of them synonyms of <<supercapacitor>>, are also used in the literature.

Conversely, in the case of a full-hybrid or rechargeable hybrid hybridization degree, the electrochemical system used, which should allow storage of a large amount of electric energy which is however not recovered at a high rate, is typically an accumulator, also designated as <<battery<<, and for example may be an accumulator of the lithium-ion type.

In the case of hybridization of the semi-hybrid type, the electrochemical system is a supercapacitor, which is a so-called <<hybrid supercapacitor>> or further <<asymmetrical supercapacitor>>. The storage and recovery characteristics for the electric energy of such a hybrid supercapacitor are a compromise between the corresponding characteristics of the supercapacitor and of the accumulator as mentioned earlier.

In an ideal scheme, it would be desirable to have a hybrid vehicle which may meet at least two of the hybridization degrees shown in the Table 1 above, or even all of these hybridization degrees. Now, as it has just been seen, meeting two or even all the hybridization degrees imposes application, in the electric system onboard the vehicle, of the corresponding electrochemical systems which are not compatible with each other. Indeed, a supercapacitor, which is part of the so-called <<power>> electrochemical systems, cannot be used in the place of an accumulator which is part of the so-called <<energy>> electrochemical systems.

In order to have such a hybrid vehicle, available, a first solution would consist of providing the electric system onboard this vehicle with the two or three electrochemical systems described above, i.e. a supercapacitor, a hybrid supercapacitor and an accumulator. However, for obvious reasons notably in terms of volume and weight, this first solution is not satisfactory, both from an economical point of view and an environmental point of view.

The object of the present invention is therefore to overcome the drawbacks of this first solution and of finding an alternative to it, which is economically viable and which furthermore meets the environmental requirements in order to have a system for storing and recovering electric energy which may be used in the electric energy system onboard a hybrid vehicle, said hybrid vehicle being able to meet at least two of the hybridization degrees as shown in Table 1 above, or even the set of the three hybridization degrees.

### DISCUSSION OF THE INVENTION

The object listed earlier as well as other ones are firstly attained by an electrochemical cell having a particular structure.

According to the invention, this electrochemical cell comprises a shell delimiting a space filled with an electrolytic solution as well as a set of at least two different electrochemical systems selected from a supercapacitor, a hybrid supercapacitor and an accumulator,
the supercapacitor comprising a positive electrode comprising activated carbon and a negative electrode comprising activated carbon,
the hybrid supercapacitor comprising a positive electrode comprising activated carbon and a negative electrode comprising a metal or a carbonaceous material for intercalating at least one alkaline metal noted as M, said material being different from activated carbon used in the positive electrode, and
the accumulator comprising a positive electrode comprising an oxide, or a polyanionic compound of a transition metal and a negative electrode comprising a carbonaceous material for intercalating at least one alkaline metal noted as M,
   the set being arranged in the space filled with the electrolytic composition.

The electrochemical cell according to the invention therefore gives the possibility of applying, within a same structure formed by the shell, two or three different electrochemical systems, in the sense that they each fit a particular degree of hybridization, micro-hybrid, semi-hybrid or further full-hybrid wsetith its rechargeable hybrid alternative.

This electrochemical cell therefore actually consists in an alternative to the juxtaposition of these same two or three electrochemical systems, while ensuring a gain in room, in weight and in material. This gain in material is increased by the fact that these electrochemical systems are arranged, not only in the same structure but furthermore in the same electrolytic solution. Thus, by putting in common one of the essential elements of these electrochemical systems that is the electrolytic solution, the electrochemical cell according to the invention further has the undeniable advantage of simplifying the making of such an electrochemical cell.

As this has just been seen, the electrochemical cell according to the invention may comprise a set formed with two different electrochemical systems selected from among a supercapacitor, a hybrid supercapacitor and an accumulator.

The electrochemical cell according to the invention may therefore comprise a set formed with a supercapacitor and a hybrid supercapacitor, with a supercapacitor and an accumulator or further with a hybrid supercapacitor and an accumulator.

The electrochemical cell according to the invention may also comprise a set formed with the three electrochemical systems and therefore comprise a supercapacitor, a hybrid supercapacitor and an accumulator.

Before continuing the discussion of the present invention and before presenting particular embodiments of the electrochemical cell, a reminder has to be made on the characteristics of the different electrochemical systems which may be applied and by specifying some of the terminologies used which were just described and which will follow.

The electrochemical system formed by a supercapacitor is a so-called <<power>> electrochemical system which has a strong power density but a low energy density. In other words, the supercapacitor is an electrochemical system which does not give the possibility of storing a large amount of electric energy but which, on the other hand, gives the possibility of storing it and of restoring it with a strong intensity.

Conventionally, the supercapacitor operates on the principle of the electrochemical double layer (Electrochemical Double Layer Capacitor and abbreviated as EDLC) and comprises positive and negative electrodes both comprising activated carbon. This electrochemical double layer is developed on each electrode/electrolytic solution interface. Because of the existence of both of these interfaces each forming an electrochemical double layer, the supercapacitor may be considered as the association in series of two condensers, one with the positive electrode and the other one with the negative electrode.

More particularly, the positive and negative electrodes of the supercapacitor are both porous electrodes comprising activated carbon.

The electrochemical system formed by an accumulator is a so-called <<energy>> electrochemical system which has a strong energy density but a low power density. In other words, the accumulator is an electrochemical system which allows storage of a large amount of electric energy but which, on the other hand, does not give the possibility of storing it and of restoring it with a strong intensity.

From among the different types of available accumulators, one is more particularly interested in an accumulator which comprises a negative electrode comprising a carbonaceous material for intercalating at least one alkaline metal noted as M and a positive electrode comprising an oxide of a transition metal or a polyanionic compound of a transition metal.

For the accumulator, which may operate both upon charging and upon discharging, it is specified that by <<positive electrode>>, is meant the electrode which acts as a cathode when the accumulator is in a discharge process, i.e. it outputs current, and which acts as an anode when this accumulator is in a charging process. Conversely, by <<negative electrode>>, is meant the electrode which acts as an anode when the accumulator is in a discharge process, i.e. when it outputs current, and which acts as a cathode when this accumulator is in a charging process.

The electrochemical system formed by a hybrid supercapacitor as for it is an intermediate electrochemical system between a so-called <<power>> electrochemical system and a so-called <<energy>> electrochemical system.

The hybrid supercapacitor comprises two electrodes, one (conventionally the positive electrode) being in a material used for one of the two electrodes of a supercapacitor and the other one (conventionally the negative electrode) being in a material used for one of the two electrodes of an accumulator. Such a hybrid supercapacitor operates on the principle according to which the storage of electric charges, at the negative electrode, occurs by means of an oxidation-reduction reaction which is notably materialized by intercalation of the alkaline element present in the electrolytic solution, while the storage of electric charges, at the positive electrode, occurs via the formation of an electrochemical double layer. This positive electrode strictly is an electrode fitting the operation of the supercapacitor.

More particularly, the positive electrode of the hybrid supercapacitor comprises activated carbon and the negative electrode comprises a metal or a carbonaceous material for intercalating at least one alkaline metal noted as M, this intercalating carbonaceous material being of course different from the activated carbon used in the positive electrode.

According to an advantageous embodiment of the invention, the set of the electrochemical cell comprises the hybrid supercapacitor.

In a first alternative, the set of this electrochemical cell further comprises the supercapacitor. Thus, the electrochemical cell comprises a set formed with the hybrid supercapacitor and the supercapacitor.

The positive and negative electrodes of the hybrid supercapacitor as well as the positive and negative electrodes of the supercapacitor may be arranged in the electrolytic solution contained in the space delimited by the shell of the electrochemical cell.

In a particularly advantageous version of this first alternative, it is quite possible to contemplate an electrochemical cell in which the positive electrode of the hybrid supercapacitor is also the positive electrode of the supercapacitor. Thus, the set does not comprise any more four electrodes, but only three, which allows an additional gain in room and in material while retaining the individual performances of each of the two electrochemical systems. This observation is clearly illustrated by the results of the cyclic voltammetry tests conducted on the electrochemical cells of the examples 1 and 2 discussed hereafter.

In a second alternative, the set of this electrochemical cell further comprises the accumulator. Thus, the electrochemical cell comprises a set formed with the hybrid supercapacitor and the accumulator.

The positive and negative electrodes of the hybrid supercapacitor as well as the positive and negative electrodes of the accumulator may be arranged in the electrolytic solution contained in the space delimited by the shell of the electrochemical cell.

In a particularly advantageous version of this second alternative, it is quite possible to contemplate an electrochemical cell in which the negative electrode of the hybrid supercapacitor, when it comprises the carbonaceous material for intercalating at least one alkaline metal M, is also the negative electrode of the accumulator. Thus, like in the case of the first alternative, the set does not comprise any more four electrodes, but only three, without being detrimental to the individual performances of each of the two electrochemical systems.

According to another advantageous application of the invention, the set of the electrochemical cell comprises the supercapacitor, the hybrid supercapacitor and the accumulator.

The positive and negative electrodes of the supercapacitor, the positive and negative electrodes of the hybrid supercapacitor as well as the positive and negative electrodes of the accumulator may, all six of them, be arranged in the electrolytic solution contained in the space delimited by the shell of the electrochemical cell.

However, it is possible to advantageously contemplate that the positive electrode of the hybrid supercapacitor also forms the positive electrode of the supercapacitor and/or that the negative electrode of the hybrid supercapacitor, when it comprises the carbonaceous material for intercalating at least one alkaline metal M, is also the negative electrode of the accumulator. Thus, the electrochemical cell may give the possibility of operating three different electrochemical systems by only applying five, or even four, electrodes arranged in the space filled with the electrolytic solution.

According to another embodiment of the invention, the set of the electrochemical cell comprises the supercapacitor and the accumulator. The positive and negative electrodes of the supercapacitor as well as the positive and negative electrodes of the accumulator are then arranged in the electrolytic solution contained in the space delimited by the shell of the electrochemical cell.

In the electrochemical cell according to the invention, the set of at least two different electrochemical systems selected from among a supercapacitor, a hybrid supercapacitor and an accumulator, is arranged in the space which is delimited by the shell and which is filled with an electrolytic solution.

Of course, this electrolytic solution should allow proper operation of each of the electrochemical systems forming the set of the electrochemical cell. This electrolytic solution comprises at least one solvent and at least one electrolyte.

Advantageously, the electrolyte is an ionic electrolyte.

Preferentially, the electrolyte comprises an alkaline metal salt fitting the formula MA and comprising a cation M⁺ of the alkaline metal, noted as M, and an anionic group, noted as A⁻.

The alkaline metal M may thus be selected from lithium Li, sodium Na, potassium K, rubidium Rb, cesium Cs and mixtures thereof. The alkaline metal M is advantageously selected from Li, Na, K and mixtures thereof.

When the set of the electrochemical cell according to the invention notably comprises the accumulator as an electrochemical system, the alkaline metal M present in the electrolyte MA is selected so that the corresponding metal cation M⁺ is intercalated into the intercalation material of the negative electrode of the accumulator so as to form with the latter a compound called “graphite intercalation compound” (GIC). In this particular case, the alkaline metal M is preferentially potassium K.

The anionic group A⁻ may, as for it, be selected from among perchlorate ClO₄⁻, tetrachloroaluminate tetrafluoroborate BF₄⁻ hexafluorophosphate PF₆⁻, hexafluoroantimonate SbF₆⁻, hexafluoroarsenate AsF₆⁻, hexafluorosilicate SiF₆⁻, thiocyanate SCN⁻, bis(fluorosulfonyl)imide or FSI⁻ (FSO₂)₂N⁻, bis(trifluoromethanesulfonyl)imide or TFSI⁻ (CF₃SO₂)₂N⁻, bis(oxalato)borate BOB⁻, oxalyldifluoroborate or difluoromono(oxalato)borate ODBF⁻, trifluoromethanesulfonate or triflate SO₃CF₃⁻ anions, and mixtures thereof. The anionic group A⁻ is advantageously the hexafluorophosphate PF₆⁻ anion.

In an advantageous version of the invention, the electrolyte is potassium hexafluorophosphate KPF₆.

Advantageously, the solvent is an organic solvent.

This solvent may notably be selected from among:
a nitrile solvent such as acetonitrile, 3-methoxypropionitrile (MPN), adiponitrile (ADP) or further glutaronitrile (GN),
a carbonate solvent which may be a linear carbonate such as dimethyl carbonate (DMC), diethyl carbonate (DEC) or further ethyl methyl carbonate (EMC), or a cyclic carbonate, such as ethylene carbonate (EC) or further propylene carbonate (PC),
a lactone solvent, such as γ-butyrolactone (GBL) or further γ-valerolactone (GVL),
a sulfone solvent, such as dimethylsulfone (DMS), ethylmethylsulfone (EMS), diethylsulfone (DES) or further sulfolane (SL),
a lactam solvent, such as N-methylpyrrolidone (NMP),
an amide solvent, such as N,N-dimethylformamide (DMF), dimethylacetamide (DMA), formamide (FA) or further N-methylformamide (NMF),
a ketone solvent, such as acetone or further methylethylketone (MEK),
a nitroalkane solvent such as nitromethane (NM) or further nitroethane (NE),
an amine solvent, such as 1,3-diaminopropane (DAP) or further ethylenediamine (EDA),
a sulfoxide solvent, such as dimethylsulfoxide (DMSO),
an ester solvent, such as ethyl acetate (EA), methyl acetate (MA) or further propyl acetate (PA),
an ether solvent, which may be linear such as dimethoxyethane (DME) or cyclic, such as dioxane, dioxolane (DIOX) or further tetrahydrofurane (THF),
an oxazolidone solvent such as 3-methyl-2-oxazolidone, and
mixtures thereof.

In an advantageous version of the invention, the solvent of the electrolytic solution is acetonitrile.

In a particular embodiment of the invention, the electrolyte is present, in the electrolytic solution, in a molar concentration comprised between 0.5 mol/l and 2 mol/l, advantageously between 0.8 mol/l and 1.5 mol/l and, preferentially which is of the order of 1 mol/l.

In a particular embodiment of the invention, at least one of the electrochemical systems of the set of the electrochemical cell may comprise, arranged between its positive and negative electrodes, at least one electrically non-conducting separation membrane. Such a separation membrane is hydraulically permeable, which means that it lets through the ions.

Nothing prevents contemplating the presence of separation membranes between the positive and negative electrodes of each of the electrochemical systems forming the set of the electrochemical cell. It is also possible to contemplate the presence of one (or two) separation membrane(s) between the pairs of electrodes of two (or three) electrochemical systems forming said set, except for the case when one (or two) electrode(s) is(are) common to said electrochemical systems. Examples 1 and 2 detailed hereafter are an illustration of these particular embodiments.

The separation membrane may be in a porous material capable of receiving the electrolytic solution in its porosity. It is then stated that the electrolytic solution impregnates this separation membrane.

In particular, a separation membrane as commercially available from Treofan, may be applied, like in the examples 1 and 2 hereafter.

In a particular embodiment of the invention, at least one of the electrodes of the electrochemical systems may comprise a current collector, this current collector advantageously appearing as a metal leaf, preferably laminated. This metal leaf, which is conventionally made in aluminium, gives the possibility of ensuring the electrical connection.

In order to form an electrode, this metal sheet is then coated, for example by coating, with a composition comprising the material adapted to the polarity of the electrode and to the electrochemical system into which this electrode will be integrated.

Hereafter will be detailed various alternatives which may be contemplated for producing the compositions forming the electro-chemically active materials of the electrodes, positive and negative, of the different electrochemical systems which may enter the structure of the set of the electrochemical cell according to the invention.

* When the electrode comprises activated carbon, which is the case of the positive and negative electrodes of the supercapacitor as well as of the positive electrode of the hybrid supercapacitor, the activated carbone is advantageously present, in the composition forming the electro-chemically active material, in a mass content of at least 60% based on the total mass of the relevant electrode, it being understood that this total mass of the relevant electrode does not integrate the mass of the current collector optionally present within said electrode. Preferably, the activated carbon is present in a mass content comprised between 65% and 95% based on the total mass of the electrode, the values of the limits of the intervals being included.

The composition of the electrode comprising activated carbon may further advantageously comprise at least one binder which contributes to ensuring mechanical cohesion of the electrode, and/or at least one electrically conducting compound.

From among the binders which may be used in this composition based on activated carbon, mention may notably be made of carboxymethylcellulose (CMC), but it remains quite conceivable to use other polymeric binders such as fluorinated polymers, polyimides, polyacrylonitriles, elastomers or further mixtures thereof. From among the elastomers, mention may more particularly be made of elastomers of the styrene-butadiene type.

From among the electrically conductive compounds, mention may be made of carbonaceous compounds other than activated carbon, like carbon black, acetylene black, graphite, carbon nanotubes, carbon fibers such as vapor grown carbon fibers (VGCF) and mixtures thereof.

* When the electrode comprises a carbonaceous material for intercalation of at least one alkaline metal M, which is the case of a negative electrode of the accumulator and which may also be the case of the negative electrode of the hybrid supercapacitor, the carbonaceous material for intercalation of at least one alkaline metal M is advantageously graphite.

The carbonaceous material for intercalating at least one alkaline metal M such as graphite is advantageously present, in the composition forming the electro-chemically active material, in a mass content of at least 60%, and preferably at least 80%, by mass based on the total mass of the relevant electrode, it being understood that this total mass of the relevant electrode does not integrate the mass of the current collector optionally present within said electrode.

Like in the case of the composition of the electrode comprising activated carbon, the composition of the electrode comprising the carbonaceous material for intercalating at least one alkaline metal M may further advantageously comprise at least one binder which contributes to ensuring the mechanical cohesion of the electrode, and/or at least one electrically conductive compound.

The binders and electrically conductive compounds which may be used in this composition based on a carbonaceous material for intercalation of at least one alkaline metal M may be the same as those which were mentioned earlier for the composition of the electrode comprising activated carbon.

* When the electrode comprises a polyanionic compound of a transition metal, which may be the case of the positive electrode of the hybrid supercapacitor, this polyanionic compound is advantageously a phosphate of a transition metal.

The electrochemical cell according to the invention may appear as different structural forms, and notably as a cylindrical battery cell, a button cell, or a pouch cell. Preferably, it appears as a pouch cell.

The present invention secondly relates to a system for storing and recovering electric energy.

According to the invention, this system for storing and recovering electric energy comprises an electrochemical cell as defined above, the advantageous characteristics of this electrochemical cell which may be taken alone or as a combination, and at least one electronic interface adapted for selecting an electrochemical system depending on a degree of hybridization.

Thus, the electronic interface gives the possibility of selecting the electrochemical system from the supercapacitor, the hybrid supercapacitor and/or the accumulator, the most adapted for the storage or recovery of electric energy depending on the degree of hybridization required in the contemplated application.

In an advantageous alternative of this system for storing and recovering electric energy, the electronic interface is further adapted for controlling the exchange of electric energy between the electrochemical systems.

Lastly, the present invention relates to a vehicle.

According to the invention, this vehicle comprises at least one system for storing and restoring electric energy as defined above, taken alone or as a combination with its advantageous alternative.

In a more particularly advantageous way, this vehicle is a hybrid vehicle, such as a car, a bus or a truck.

Other features and advantages of the invention will be become better apparent upon reading the additional description which follows, which relates to particular embodiments of the invention.

This additional description, which notably refers to FIGS. 1 to 9 as appended, is given as an illustration of the object of the invention and is by no means a limitation of this object.

### SHORT DESCRIPTION OF THE DRAWINGS

FIG. 1 is a photograph of an electrochemical cell according to the invention comprising two electrochemical systems, a supercapacitor and a hybrid supercapacitor, each electrochemical system comprising a positive electrode and a negative electrode.

FIG. 2 is a schematic illustration in a longitudinal sectional view of the internal structure of the electrochemical cell of FIG. 1.

FIG. 3 illustrates the curve obtained in cyclic voltammetry expressing the change in the current (noted as I and expressed in mA) according to the potential difference (noted as E and expressed in V) applied between the positive and negative electrodes of the electrochemical system formed by the hybrid supercapacitor of the electrochemical cell of FIG. 1.

FIG. 4 illustrates the curve obtained in cyclic voltammetry expressing the change in the current (noted as I and expressed in mA) depending on the potential difference (noted as E and expressed in V) applied between the positive and negative electrodes of the electrochemical system formed by the supercapacitor of the electrochemical cell of FIG. 1.

FIG. 5 is a photograph of an electrochemical cell according to the invention comprising two electrochemical systems, a supercapacitor and a hybrid supercapacitor, both of these electrochemical systems sharing the same positive electrode.

FIG. 6 is a schematic illustration in a longitudinal sectional view of the internal structure of the electrochemical cell of FIG. 5.

FIG. 7 illustrates the curve obtained in cyclic voltammetry expressing the change in the current (noted as I and expressed in mA) depending on the potential difference (noted as E and expressed in V) applied between the positive and negative electrodes of the electrochemical system formed by the hybrid supercapacitor of the electrochemical cell of FIG. 5.

FIG. 8 illustrates the curve obtained in cyclic voltammetry expressing the change in the current (noted as I and expressed in mA) depending on the potential difference (noted as E and expressed in V) applied between the positive and negative electrodes of the electrochemical system formed by the supercapacitor of the electrochemical cell of FIG. 5.

FIG. 9 is a block diagram of a system for storing and restoring electric energy according to the invention.

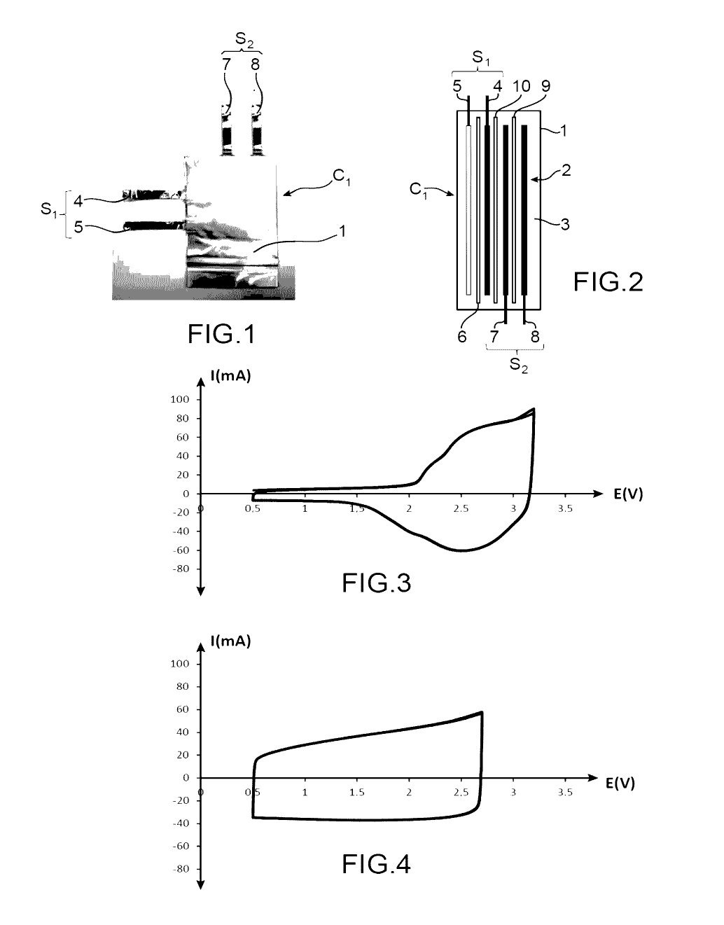

It is specified that the elements common to FIGS. 1, 2, 5 and 6 are identified by the same numerical reference.

### DETAILED DISCUSSION OF PARTICULAR EMBODIMENTS

The present examples 1 and 2 illustrate the behavior of an electrochemical cell according to the invention and applying a set of two different electrochemical systems, a supercapacitor and a hybrid supercapacitor.

Example 3 illustrates a system for storing and restoring electric energy according to the invention.

Each electrode used within the scope of these examples 1 and 2 was prepared by coating, on an aluminium collector with a thickness of 30 μm, of one or the other of the compositions A and B below.

Composition A, which allows preparation of an electrode comprising activated carbon, comprises, in a mass percentage based on the total mass of said composition A:
84% of activated carbon of reference YP-50F marketed by Kuraray Chemical,
4% of styrene-butadiene binder of reference Styrofan® LD 417 marketed by BASF,
8% of carbon black of reference C-NERGY™ SUPER C65 marketed by Timcal, and
4% of carboxymethylcellulose (2% by mass in water) of reference 7HXF marketed by Aqualon.

Composition B, which allows preparation of an electrode comprising graphite as a material for intercalating at least one alkaline metal, comprises in mass percentage based on the total mass of said composition B:
94% of graphite carbon of reference Timrex® SLP30 marketed by Timcal,
2% of carbon black of reference C-NERGY™ SUPER C65 marketed by Timcal,
2% of carboxymethylcellulose (2% by mass in water) of reference 7HXF marketed by Aqualon, and
2% of styrene-butadiene binder of reference Styrofan® LD 417 marketed by BASF.

The electrodes were separated by means of microporous separation membranes with a thickness of 25 μm and of reference TreoPore® PDA 25 marketed by Treofan.

The electrolytic solution used comprises potassium hexafluorophosphate KPF₆ as an electrolyte, at a molar concentration of 1 mol/l in acetonitrile as a solvent.

### EXAMPLE 1

### Electrochemical Cell with Four Electrodes

The electrochemical cell of Example 1, noted as C₁, a photograph of which is reproduced in FIG. 1, appears as a pouch cell.

With reference to the schematic illustration of FIG. 2, this electrochemical cell C₁ comprises a shell 1 delimiting a space 2 which is filled with an electrolytic solution 3, the composition of which has been detailed earlier (KPF₆ in 1M acetonitrile).

The electrochemical cell C₁ moreover comprises a set of two electrochemical systems S₁ and S₂.

The electrochemical system S₁, which is a hybrid supercapacitor, comprises a positive electrode 4 and a negative electrode 5. The positive electrode 4 is formed by coating the composition A on the aluminium collector, the end of which is visible on the photograph of FIG. 1. The negative electrode 5 is formed by coating the composition B on the aluminium collector, the end of which is also visible on the photograph of FIG. 1. The electrochemical system S₁ further comprises a separation membrane 6 arranged between the positive electrode 4 and the negative electrode 5.

The electrochemical system S₂, which is a supercapacitor, comprises a positive electrode 7 and a negative electrode 8, these electrodes 7 and 8 both being formed by coating, on their respective aluminium collector, the respective ends of which are also visible on the photograph of FIG. 1, of the composition A described above. The electrochemical system S₂ further comprises a separation membrane 9 arranged between the positive electrode 7 and the negative electrode 8.

The electrochemical cell C₁ further comprises a separation membrane 10 arranged between the electrochemical systems S₁ and S₂.

Cyclic voltammetry tests were conducted for confirming the operation of each of the electrochemical systems S₁ and S₂ of the electrochemical cell C₁.

In a first step, the cyclic voltammetry test was conducted for evaluating the operation of the electrochemical system S₁, by producing the electric connection between the positive electrode 4 and the negative electrode 5. The corresponding curve as obtained during cycling carried out at a sweep rate of 10 mV/s, is illustrated in FIG. 3.

It is observed that this curve of FIG. 3 corresponds to a typical voltammogram of a hybrid supercapacitor, this voltammogram comprising a first portion, located between 0.5 V and 1.5 V, which has the aspect of a supercapacitor, and a second portion, located between 1.5 V and 3.2 V, which has the aspect of an accumulator. The electrochemical system S₁ of the electrochemical cell C₁ is therefore actually functional.

In a second step, the cyclic voltammetry test was conducted for evaluating the operation of the electrochemical system S₂, by producing the electric connection between the positive electrode 7 and the negative electrode 8. The corresponding curve as obtained during cycling carried out at a sweep rate of 10 mV/s, is illustrated in FIG. 4.

It is observed that this curve of FIG. 4 corresponds to a typical voltammogram of a supercapacitor, demonstrating that the electrochemical system S₂ of the electrochemical cell C₁ is therefore also actually functional.

### EXAMPLE 2

### Electrochemical Cell with Three Electrodes

The electrochemical cell of Example 2, noted as C₂, a photograph of which is reproduced in FIG. 5, also appears as a pouch cell.

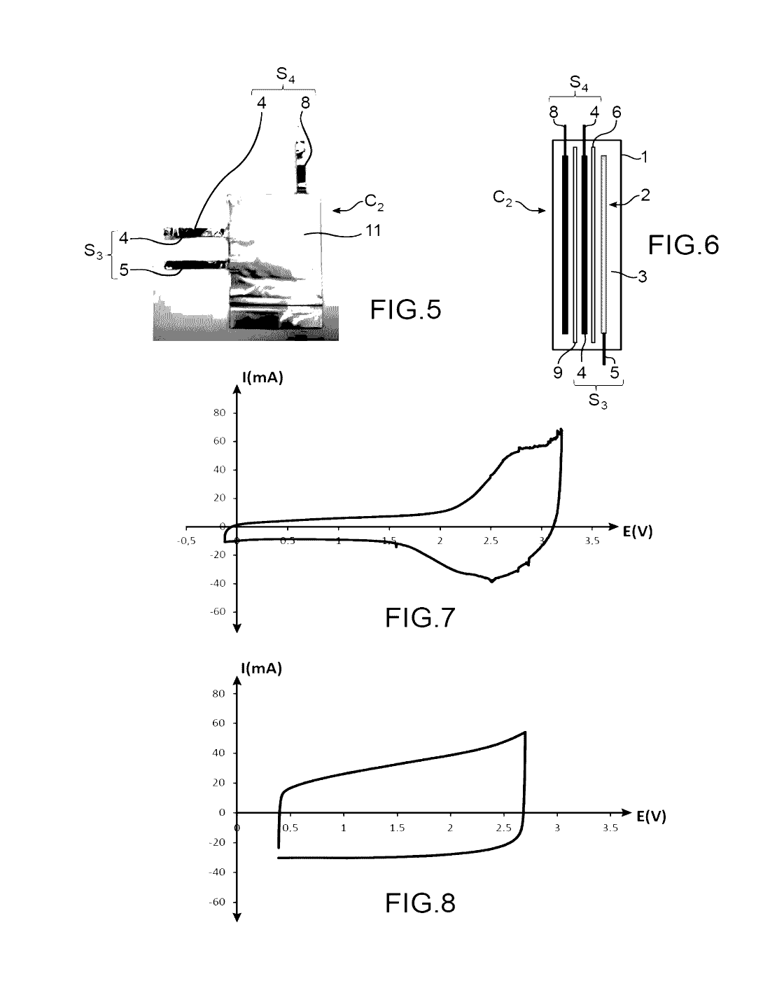

With reference to the schematic illustration of FIG. 6, this electrochemical cell C₂ comprises a shell 1 delimiting a space 2 which is filled with the same electrolytic solution 3 as the one used in the electrochemical cell C₁ of Example 1 (KPF₆ in 1M acetonitrile).

The electrochemical cell C₂ moreover comprises a set formed with two electrochemical systems S₃ and S₄.

The electrochemical system S₃ is a hybrid supercapacitor and comprises a positive electrode 4 as well as a negative electrode 5. Like in the electrochemical system S₁ of Example 1, the positive electrode 4 of the electrochemical cell C₂ is obtained by coating the composition A on a first aluminium collector, while the negative electrode 5 is obtained by coating the composition B on a second aluminium collector. The electrochemical system S₃ further comprises a separation membrane 6 arranged between the positive electrode 4 and the negative electrode 5.

The electrochemical system S₄ is a supercapacitor and comprises as a positive electrode, the positive electrode 4 as well as a negative electrode 8. This negative electrode 8 is also obtained by coating the composition A on a third aluminium collector. The electrochemical system S₄ further comprises a separation membrane 9 arranged between the positive electrode 4 and the negative electrode 8.

The positive electrode 4 is therefore an electrode common to the two electrochemical systems S₃ and S₄ since it makes up both the positive electrode of the electrochemical system S₃ and the positive electrode of the electrochemical system S₄. Consequently, and by design, no additional separation membrane is arranged between the electrochemical systems S₃ and S₄.

Cyclic voltammetry tests were conducted for confirming the operation of each of the electrochemical systems S₃ and S₄ of the electrochemical cell C₂.

In a first step, the cyclic voltammetry test was conducted in order to evaluate the operation of the electrochemical system S₃, by producing the electric connection between the positive electrode 4 and the negative electrode 5. The corresponding curve as obtained during cycling carried out at a sweep rate of 10 mV/s, is illustrated in FIG. 7.

It is observed that this curve of FIG. 7 has a similar aspect to that of the curve of FIG. 3 and therefore corresponds to a typical voltammogram of a hybrid supercapacitor, with a first curve portion characteristic of a supercapacitor, and a second portion characteristic of an accumulator. The electrochemical system S₃ of the electrochemical cell C₂ is therefore actually functional.

In a second step, the cyclic voltammetry test was conducted for evaluating the operation of the electrochemical system S₄, by producing the electric connection between the positive electrode 4 and the negative electrode 8. The corresponding curve as obtained during cycling carried out at a sweep rate of 10 mV/s, is illustrated in FIG. 8.

It is observed that this curve of FIG. 8 has a similar aspect to that of the curve of FIG. 4 and therefore corresponds to a typical voltammogram of a supercapacitor, demonstrating that the electrochemical system S₄ of the electrochemical cell C₂ is therefore also actually functional.

### EXAMPLE 3

### System for Storing and Restoring Electric Energy

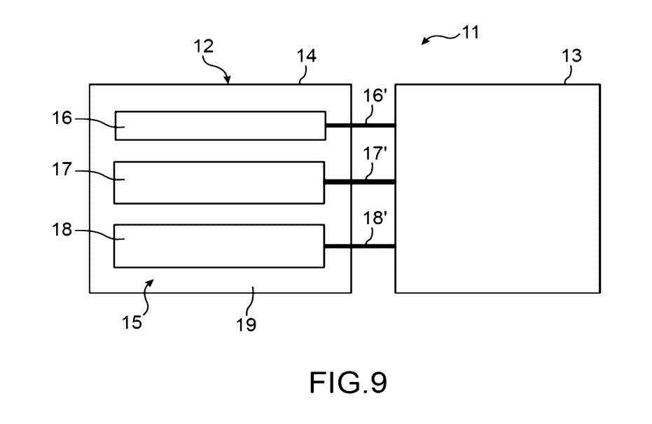

A system for storing and restoring electric energy according to the invention is illustrated in FIG. 9.

This system for storing and restoring electric energy 11 comprises an electrochemical cell 12 and an electronic interface 13.

The electrochemical cell 12 comprises a shell 14 delimiting a space 15 in which is arranged a set formed with three different electrochemical systems 16, 17, 18, i.e. a supercapacitor, a hybrid supercapacitor and an accumulator. This space 15 further comprises an electrolytic solution 19 formed with a solvent and an electrolyte, this electrolytic solution 19 being compatible with the operation of each of the electrochemical systems 16, 17 and 18.

Each electrochemical system 16, 17, 18 is connected to the electronic interface 13, with connection means, respectively 16′, 17′, 18′.

The electronic interface 13 is adapted for the selection of an electrochemical system, from among the three electrochemical systems 16, 17 and 18 of the electrochemical cell 12, according to a degree of hybridization.

This electronic interface 13 is further advantageously adapted for controlling the exchange of electric energy between the electrochemical systems 16, 17 and 18.

1-21 (canceled)

22. An electrochemical cell comprising:
a shell delimiting a space filled with an electrolytic solution; and
a set of at least two different electrochemical systems selected from a supercapacitor, a hybrid supercapacitor, and an accumulator; wherein
the supercapacitor comprises a positive electrode comprising activated carbon and a negative electrode comprising activated carbon;
the hybrid supercapacitor comprises a positive electrode comprising activated carbon and a negative electrode comprising a metal or a carbonaceous material for intercalating at least one alkaline metal noted as M, the material being different from the activated carbon used at the positive electrode;
the accumulator comprises a positive electrode comprising an oxide, or a polyanionic compound, of a transition metal and a negative electrode comprising a carbonaceous material for intercalating at least one alkaline metal noted as M; and
wherein the set is arranged in a space filled with the electrolytic solution.

23. The electrochemical cell according to claim 22, wherein the set comprises the hybrid supercapacitor.

24. The electrochemical cell according to claim 23, wherein the set further comprises the supercapacitor.

25. The electrochemical cell according to claim 24, wherein the positive electrode of the hybrid supercapacitor is also the positive electrode of the supercapacitor.

26. The electrochemical cell according to claim 23, wherein the set further comprises the accumulator.

27. The electrochemical cell according to claim 26, wherein the negative electrode of the hybrid supercapacitor, when it comprises the carbonaceous material for intercalating at least one alkaline metal M, is also the negative electrode of the accumulator.

28. The electrochemical cell according to claim 22, wherein the set comprises the supercapacitor, the hybrid supercapacitor, and the accumulator.

29. The electrochemical cell according to claim 22, wherein the electrolytic solution comprises at least one solvent and at least one electrolyte, the electrolyte comprising an alkaline metal salt fitting the formula MA and comprising a cation M⁺ of the alkaline metal M and an anionic group A⁻.

30. The electrochemical cell according to claim 22, wherein the alkaline metal M is selected from Li, Na, K, Rb, Cs and mixtures thereof.

31. The electrochemical cell according to claim 29, wherein the anionic group A⁻ is selected from ClO₄⁻, AlCl₄⁻, BF₄⁻, PF₆⁻, SbF₆⁻, AsF₆⁻, SiF₆⁻, SCN⁻, FSI⁻, TFSI⁻, BOB⁻, ODBF⁻, SO₃CF₃⁻ and mixtures thereof.

32. The electrochemical cell according to claim 29, wherein the electrolyte is KPF₆.

33. The electrochemical cell according to claim 29, wherein the solvent is an organic solvent, or selected from a nitrile solvent, a carbonate solvent, a lactone solvent, a sulfone solvent, a lactam solvent, an amide solvent, a ketone solvent, a nitroalkane solvent, an amine solvent, a sulfoxide solvent, an ester solvent, an ether solvent, an oxazolidone solvent, and mixtures thereof.

34. The electrochemical cell according to claim 29, wherein the electrolyte is present in the electrolytic solution in a molar concentration between 0.5 mol/l and 2 mol/l.

35. The electrochemical cell according to claim 22, wherein at least one of the electrochemical systems comprises, arranged between its positive and negative electrodes, at least one electrically non-conductive separation membrane.

36. The electrochemical cell according to claim 22, wherein at least one of the electrodes of the electrochemical systems comprises a current collector, the current collector appearing as a metal sheet.

37. The electrochemical cell according to claim 22, wherein, when the electrode comprises activated carbon, the activated carbon is present in a mass content of at least 60% based on total mass of the relevant electrode.

38. The electrochemical cell according to claim 22, wherein the carbonaceous material for intercalating at least one alkaline metal M is graphite.

39. The electrochemical cell according to claim 22, being a cylindrical cell, a button cell, or a pouch cell.

40. A system for storing and restoring electric energy comprising an electrochemical cell according to claim 22 and at least one electronic interface configured to select an electrochemical system according to a degree of hybridization.

41. The system for storing and restoring electric energy according to claim 40, wherein the electronic interface is further configured to control exchange of electric energy between the electrochemical systems.

42. A vehicle, in particular a hybrid vehicle, comprising at least one system for storing and restoring electric energy according to claim 40.
